(19) United States
(12) Patent Application Publication
(10) Pub. No.: US 2007/0011901 A1
(43) Pub. Date: Jan. 18, 2007

(54) Cleaning device for oil dipsticks

(76) Inventor: Min-Lan Kou, Austin, TX (US)

Correspondence Address: ROSENBERG, KLEIN & LEE, 3458 ELLICOTT CENTER DRIVE-SUITE 101, ELLICOTT CITY, MD, 21043, US

(21) Appl. No.: 11/179,571

(22) Filed: Jul. 13, 2005

(51) Int. Cl. G01F 23/04

(52) U.S. Cl. 33/725

(57) ABSTRACT

A cleaning device for oil dipsticks includes two parts pivotably connected with each other and each part includes clamping portion at a first end thereof and a handle at a second end thereof. A cleaning member is connected to the two handles. The user pivots the two handles toward each other to wipe the oil on the oil dipstick by the cleaning member and the device can conveniently clamps to any part in the engine room when not in use.

### FIELD OF THE INVENTION

The present invention relates to a cleaning device for oil dipstick of vehicles, the device easily clamps to the oil stick and provides cleaning member for conveniently remove oil on the dipstick.

### BACKGROUND OF THE INVENTION

A conventional oil dipstick is inserted into the engine casing and dips into the engine oil so that when checking the engine oil, the user has to pull the dipstick out from the engine casing and check the level of the engine oil on the dipstick. The user has to prepare a fabric to wipe the oil on the dipstick and then insert the dipstick again and then pull it out to check the actual level of the engine oil on the dipstick. It is noted that when the drivers want to check the engine oil, there is no proper fabric prepared to wipe out the oil on the dipstick, or the fabric was put randomly and cannot be found when needed. FIG. 8 discloses a conventional cleaning device for oil dipstick and includes a frame which includes an open top and two sidewalls which are flexible and can be squeezed inward. Each sidwall includes a support plate 82 extending from an inside thereof and a cleaning member 83 is engaged on the two support plates 82 so that when the user squeezes the two sidwalls 81, the cleaning member 83 is curved and clamps the oil dipstick which is then pulled to let the oil be removed by the cleaning member 83. A magnet 84 is connected to an inner end of the frame so that the device can be attached on any metal part in the engine room and can be easily found. However, the magnet 84 cannot firmly hold the cleaning device and may drop from the metal part because of shaking or vibrating.

The present invention intends to provide a cleaning device for oil dipstick that includes a clamp mechanism for firmly clamping to a part in the engine part without worry of lost.

### SUMMARY OF THE INVENTION

The present invention relates to a cleaning device for oil dipsticks and comprises a first part and a second part which is pivotably connected to the first part at a middle portion thereof. Each of the first and second parts has a clamping portion at a first end thereof and a first handle at a second end thereof. A torsion spring is located between the two parts for biasing the two respective handles to expand away from each other. A cleaning member is connected to the two handles.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view of the cleaning device of the present invention;

FIG. 2 is an exploded view to show the cleaning device of the present invention;

FIG. 3 is a cross sectional view of the cleaning device of the present invention;

FIG. 4 is a cross sectional view of the cleaning device of the present invention, wherein the oil dipstick is clamped by the cleaning member;

FIG. 5 shows that two cleaning devices clamp to two parts in the engine room;

FIG. 6 shows that the cleaning device clamps to a head ring of the oil dipstick;

FIG. 7 shows another embodiment of cleaning device of the present invention, and

FIG. 8 shows a conventional cleaning device.

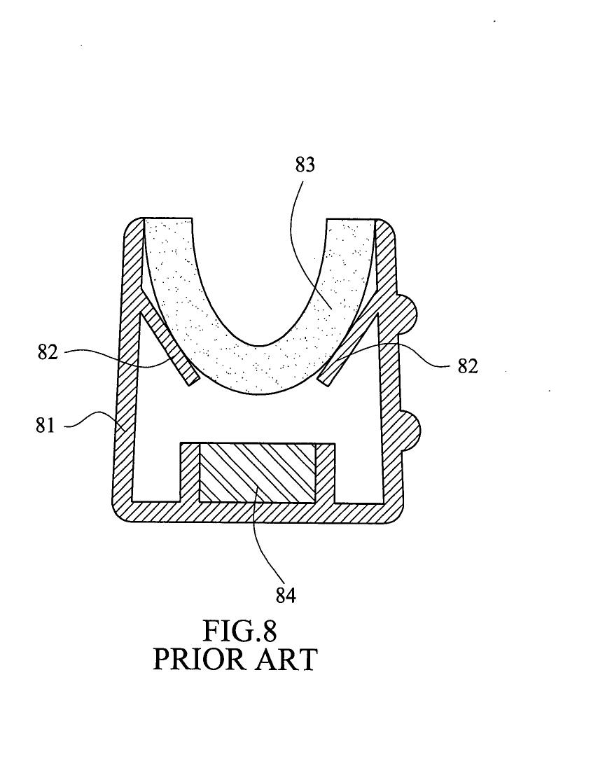

### DETAILED DESCRIPTION OF THE PREFERRED EMBODIMENT

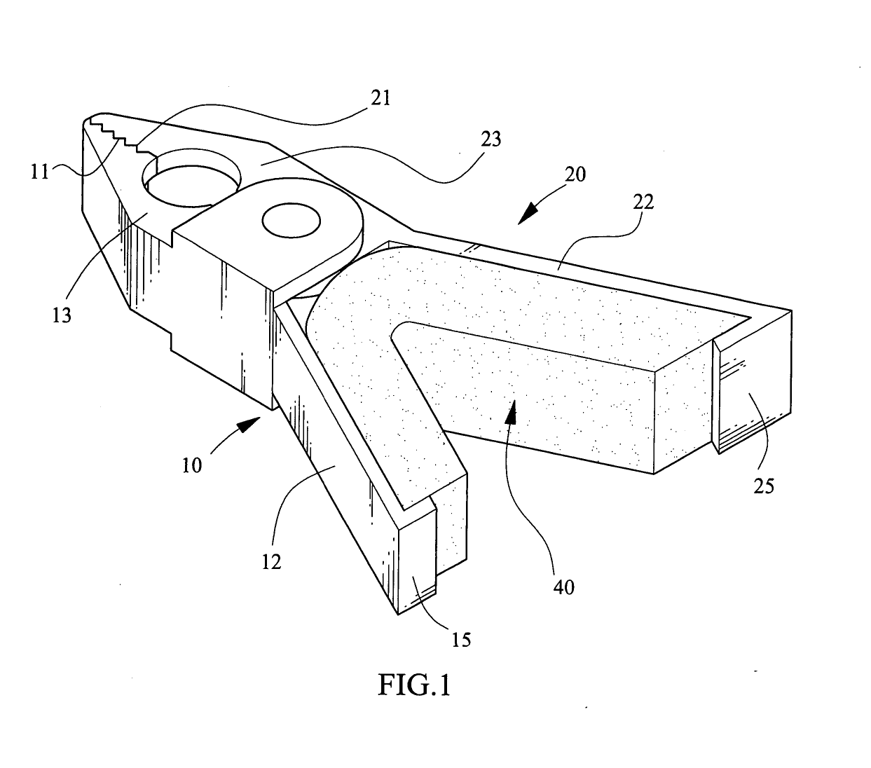

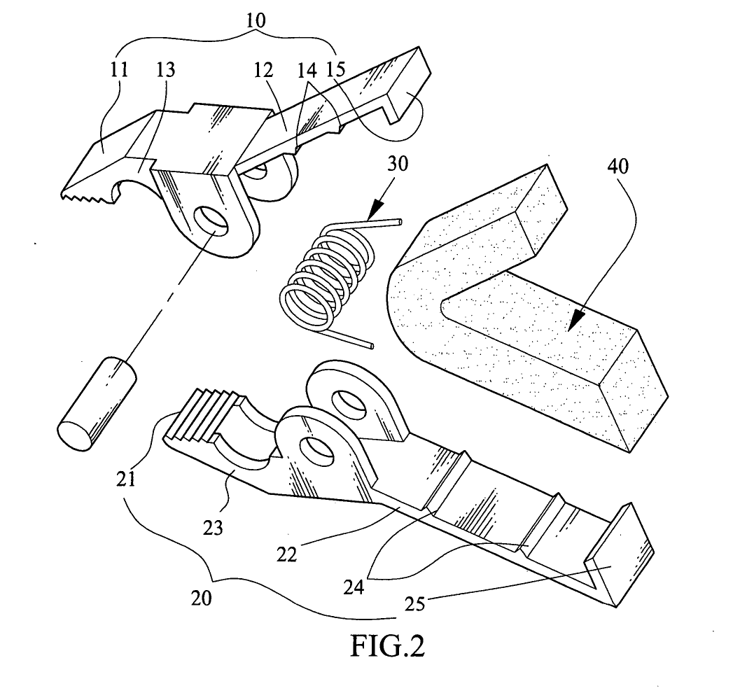

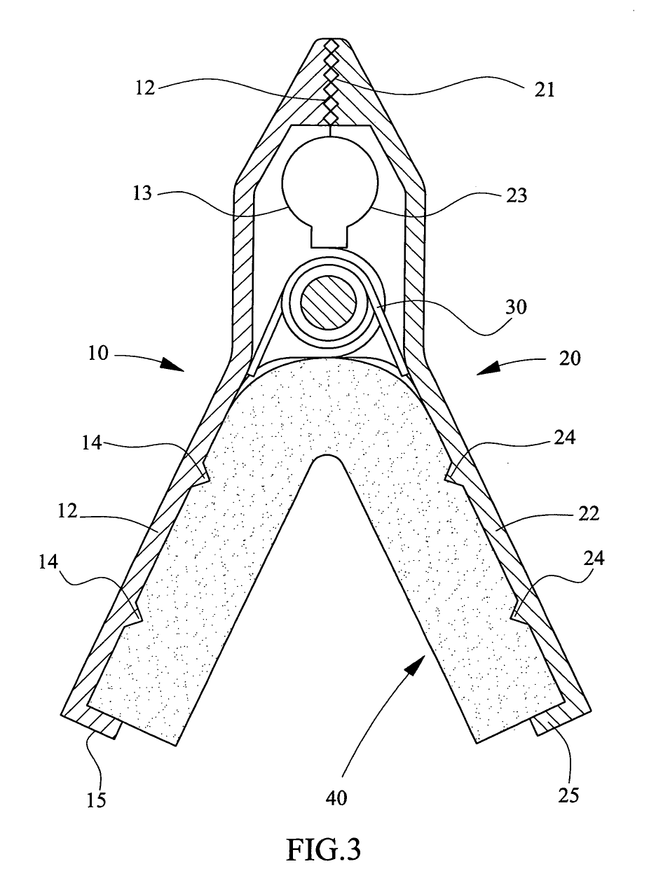

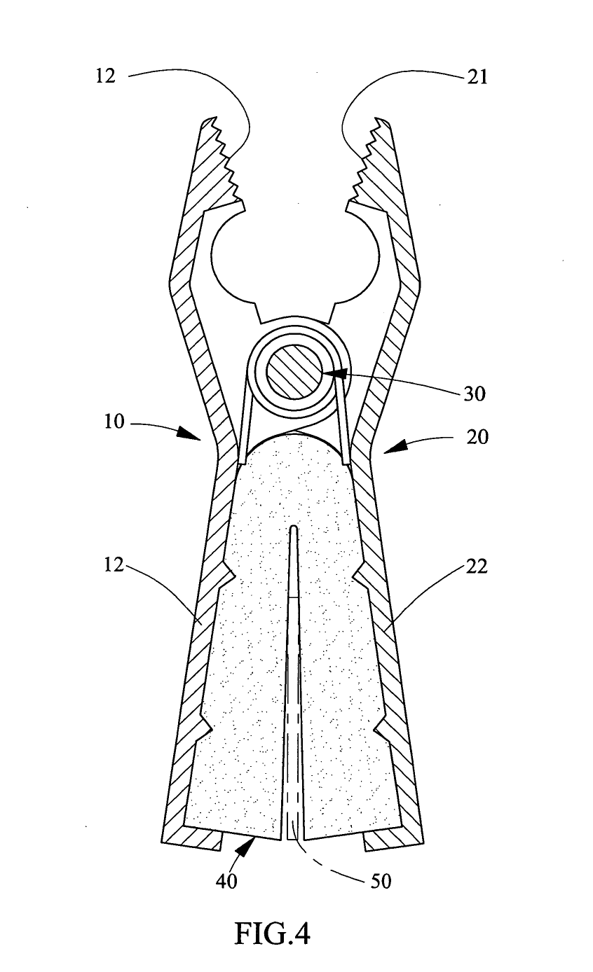

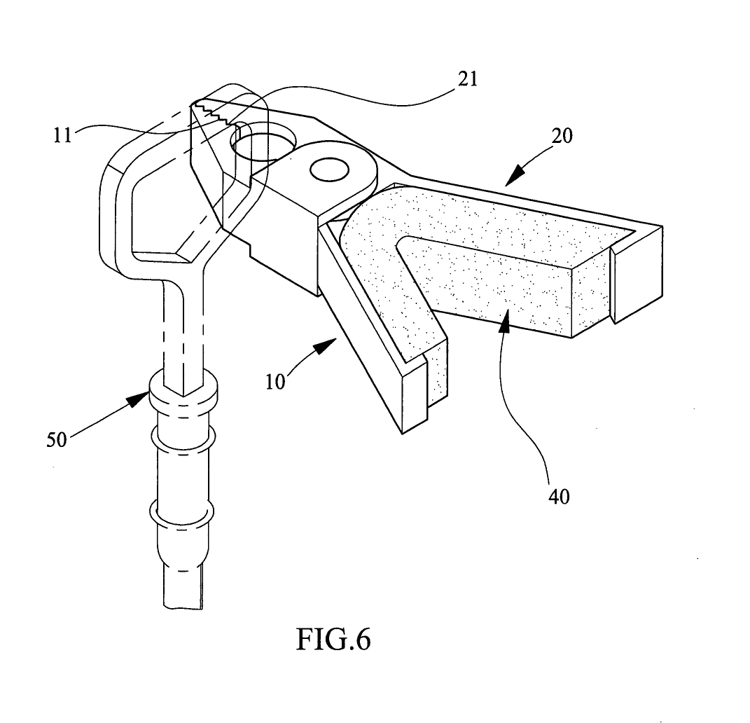

Referring to FIGS. 1 to 6, the cleaning device for oil dipsticks of the present invention comprises a first part 10 and a second part 20 which is pivotably connected to the first part 10. The first part 10 has a first clamping portion 11 at a first end thereof and a first handle 12 at a second end of the first part 10. The first clamping portion 11 includes teeth defined in an inside thereof. A plurality of ridges 14, 24 extend from an inside of the first handle 12 and an end flange 15 extends inward from a distal end of the first handle 12.

The second part 20 has a second clamping portion 21 at a first end thereof and a second handle 22 at a second end of the second part 20. The second clamping portion 21 includes teeth defined in an inside thereof. Each of the first and second parts 10, 20 includes two lugs at mediate portion thereof and a pin extends through the lugs of the first and second parts 10, 20. A torsion spring 30 is mounted to the pin and two legs of the torsion spring 30 contact the first and second handles 12, 22 so as to bias the first and second handles 12, 22 expanding away from each other. A cleaning member 40 is connected to the two respective insides of the first and second handles 12, 22. The ridges 14, 24 provide good grasp function for positioning the cleaning member 40 and two ends of the cleaning member 40 are stopped by the two respective flanges 15, 25.

The user may put the oil stick 50 between the first and second handles 12, 22 and pivot the two handles 12, 22 toward each other and pull the oil dipstick 50 so that the oil on the oil dipstick 50 is wiped by the cleaning member 40. The cleaning member 40 can be made by any known material such as a piece of fabric or piece of wool fabric.

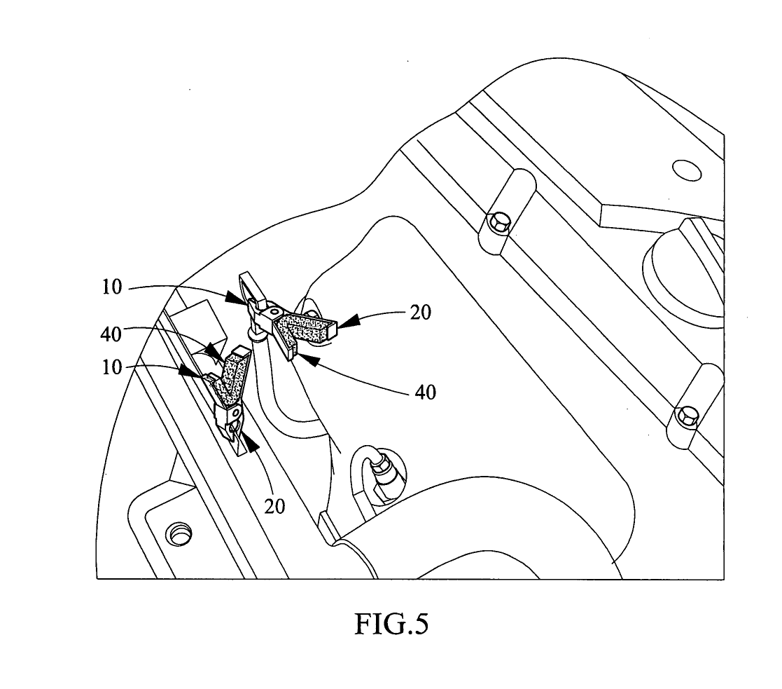

As shown in FIG. 5, the cleaning device can clamp to any part in the engine room or clamp to a head ring of the oil dipstick 50 when not in use. Therefore, the cleaning device is well positioned and does not drop.

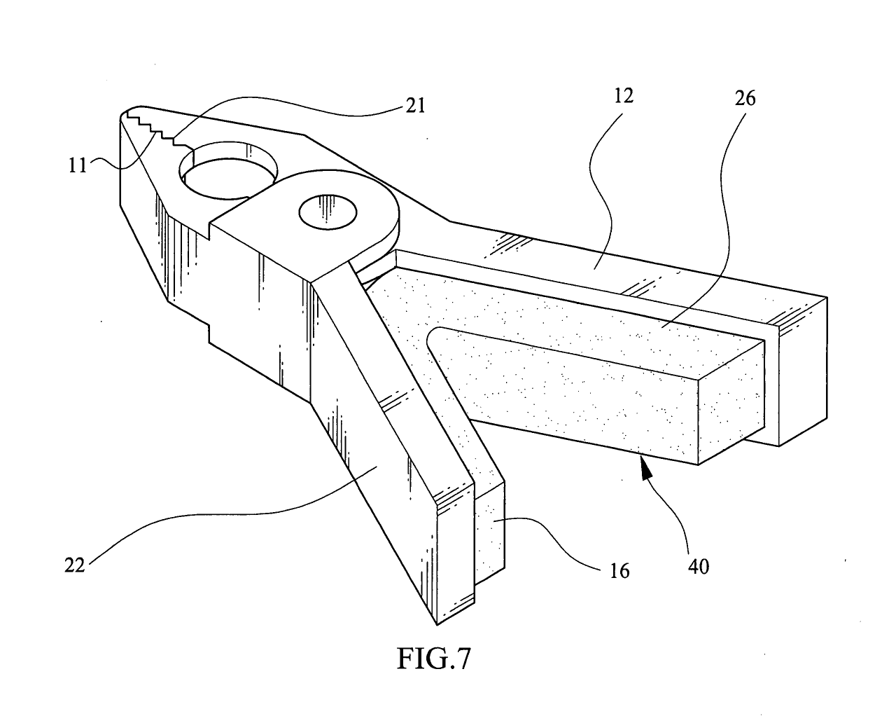

As shown in FIG. 7, each of the first and second handles 12, 22 has a recess 16/26 and the cleaning member 40 is engaged with the two respective recesses 16, 26.

While we have shown and described the embodiment in accordance with the present invention, it should be clear to those skilled in the art that further embodiments may be made without departing from the scope of the present invention.

What is claimed is:

1. A cleaning device for oil dipsticks, comprising:
a first part having a first clamping portion at a first end thereof and a first handle at a second end of the first part;
a second part having a second clamping portion at a first end thereof and a second handle at a second end of the second part, the first and second parts pivotably connected with each other at a mediate portion thereof and a torsion spring located between the first and second parts for biasing the first and second handles expanding away from each other;
a cleaning member connected to the first and second handles.

2. The device as claimed in claim 1, wherein each of the first and second handles includes a plurality of ridges extending from an inside thereof so as to position the cleaning member.

3. The device as claimed in claim 1, wherein each of the first and second handles includes an end flange extending inward from a distal end thereof, two ends of the cleaning member are stopped by the two respective flanges.

4. The device as claimed in claim 1, wherein each of the first and second clamping portions includes teeth defined in an inside thereof.

5. The device as claimed in claim 1, wherein each of the first and second parts includes two lugs and a pin extends through the lugs of the first and second parts, the torsion spring is mounted to the pin and two legs of the torsion spring contact the first and second handles.

6. The device as claimed in claim 1, wherein each of the first and second handles has a recess and the cleaning member is engaged with the two respective recesses.

7. The device as claimed in claim 1, wherein the cleaning member is a piece of fabric.

8. The device as claimed in claim 1, wherein the cleaning member is a piece of wool fabric.
